(19) United States
(12) Patent Application Publication
(10) Pub. No.: US 2025/0131328 A1
(43) Pub. Date: Apr. 24, 2025

(54) ELECTRONIC DEVICE AND METHOD FOR DISTILLING INPUT FEATURES THROUGH ARTIFICIAL NEURAL NETWORK MODEL

(71) Applicant: INEEJI Co., Ltd, Seongnam-si (KR)

(72) Inventors: Gi Young JEON, Seoul (KR); Jae Sik CHOI, Seoul (KR)

(73) Assignee: INEEJI Co., Ltd., Seongnam-si (KR)

(21) Appl. No.: 18/631,200

(22) Filed: Apr. 10, 2024

(30) Foreign Application Priority Data
Oct. 19, 2023 (KR) 10-2023-0140582

(51) Int. Cl. G06N 20/00

(52) U.S. Cl. CPC G06N 20/00

(57) ABSTRACT

Provided are a device and method for detecting input features of an artificial neural network model. The method includes comparing an output of an artificial neural network model with a first input to extract a first local attribution for a feature of the first input, extracting a portion of the first local attribution of which an absolute value is a threshold or more using a mask extractor, and updating the first input with a second input by applying an extraction result to the first input.

### CROSS-REFERENCE TO RELATED APPLICATION

This application claims priority to and the benefit of Korean Patent Application No. 10-2023-0140582, filed on Oct. 19, 2023, the disclosure of which is incorporated herein by reference in its entirety.

### BACKGROUND

### 1. Field of the Invention

The present disclosure relates to a device and method for distilling input features through an artificial neural network model.

### 2. Discussion of Related Art

Deep neural networks (DNNs) are increasingly being applied to many fields such as autonomous driving, medical prediction, and time-series forecasting. With this development, recent models have become so large and complex that humans are unable to investigate and understand their internal decision-making mechanisms. It is important to identify and analyze the reasons for predictions of models. This is because a malfunctioning model or an unsupported decision may cause a serious problem. In an effort to provide evidence for a model's decisions, input attribution is being researched, particularly in visual tasks. An input attribution method aims to measure how much each input feature contributes to a prediction of a model. The output of this method has the form of a heatmap to provide the relative importance of input features, which helps to find human-level semantics in the input features. However, it may still be difficult to obtain reliable input attributions. This is because (1) the highly non-linear structure of modern DNNs makes it difficult to correctly track the relationship between inputs and outputs, and (2) the unavailability of ground truth makes it difficult to quantitatively measure the reliability of attribution methods.

### SUMMARY OF THE INVENTION

The present disclosure is directed to providing a device and method for distilling input features through an artificial neural network model.

Technical problems to be achieved by the present disclosure are not limited to that described above, and other technical problems which have not been described will be clearly understood by those skilled in the technical field to which the present disclosure pertains from the present specification and the accompanying drawings.

According to an aspect of the present disclosure, there is provided a method of distilling input features through an artificial neural network model, the method including comparing an output of an artificial neural network model with a first input to extract a first local attribution for a feature of the first input, extracting a portion of the first local attribution of which an absolute value is a threshold or more using a mask extractor, and updating the first input with a second input by applying an extraction result to the first input.

The method may further include comparing the output of the artificial neural network model with the second input to extract a second local attribution for the second input and acquiring an aggregated attribution by aggregating the first local attribution and the second local attribution.

The acquiring of the aggregated attribution may include performing postprocessing on the first local attribution and the second local attribution. The postprocessing may include normalization and upsampling.

The mask extractor may include a first mask configured to set the threshold on the basis of a distribution of the first local attribution and determine an attribution of a portion of the first local attribution which is the threshold or less to be 0.

The updating of the first input with the second input may include removing the portion of the first local attribution of which the attribution is determined to be 0.

The mask extractor may include a second mask configured to remove noise and outliers of the first local attribution.

The first local attribution may be a discrete sequence of anchor points.

The extracting of the first local attribution may include generating an attribution heatmap of the first local attribution.

According to another aspect of the present disclosure, there is provided an electronic device for distilling input features, the electronic device including a memory configured to store instructions and a processor configured to execute the instructions. The processor may compare an output of an artificial neural network model with a first input to extract a first local attribution for a feature of the first input, extract a portion of the first local attribution of which an absolute value is a threshold or more using a mask extractor, and update the first input with a second input by applying an extraction result to the first input.

The processor may compare the output of the artificial neural network model with the second input to extract a second local attribution for the second input and acquire an aggregated attribution by aggregating the first local attribution and the second local attribution.

The processor may perform postprocessing on the first local attribution and the second local attribution. The postprocessing may include normalization and upsampling.

The mask extractor may include a first mask configured to set the threshold on the basis of a distribution of the first local attribution and determine an attribution of a portion of the first local attribution which is the threshold or less to be 0.

The processor may update the first input with the second input and remove the portion of the first local attribution of which the attribution is determined to be 0.

The mask extractor may include a second mask configured to remove noise and outliers of the first local attribution.

The first local attribution may be a discrete sequence of anchor points.

The processor may extract the first local attribution and generate an attribution heatmap of the first local attribution.

Solutions of the present disclosure are not limited to those described above, and other solutions which have not been described will be clearly understood by those skilled in the technical field to which the present disclosure pertains from the present specification and the accompanying drawings.

### BRIEF DESCRIPTION OF THE DRAWINGS

The above and other aspects of the present disclosure will become more apparent to those of ordinary skill in the art by describing exemplary embodiments thereof in detail with reference to the accompanying drawings, in which:

FIG. 1 is a block diagram illustrating a method of distilling input features through an artificial neural network model according to an exemplary embodiment;

FIG. 2 is a flowchart illustrating operations of a processor according to an exemplary embodiment;

FIG. 3 is a schematic diagram illustrating a mask extractor according to an exemplary embodiment;

FIG. 4 is a schematic diagram illustrating local attributions and postprocessing according to an exemplary embodiment;

FIGS. 5 to 8 are diagrams illustrating integrated gradient (IG) and FullGrad (FG) according to an exemplary embodiment;

FIGS. 9 and 10 are diagrams illustrating results of a mask extractor according to an exemplary embodiment; and

FIG. 11 is a block diagram of an electronic device according to an exemplary embodiment.

### DETAILED DESCRIPTION OF EXEMPLARY EMBODIMENTS

Specific structural and functional descriptions of embodiments are disclosed for illustrative purposes only and may be implemented in various modified forms. Accordingly, actual implementations are not limited to the specific forms. embodiments disclosed, and the scope of this specification includes modifications, equivalents, or substitutions incorporated into the technical spirit described in the embodiments.

Terms such as “first,” “second,” and the like may be used to describe various components, but these terms are construed only for the purpose of distinguishing one component from others. For example, a first component may be named a second component, and similarly, a second component may be named a first component.

When a component is referred to as being “connected to” another component, the two components may be directly coupled or connected to each other, or still another component may be interposed therebetween.

Singular expressions include plural expressions unless the context clearly indicates otherwise. In this specification, the terms “include,” “have,” and the like indicate the presence of described features, integers, steps, operations, components, parts, or combinations thereof and do not preclude the presence or addition of one or more other features, integers, steps, operations, components, parts, or combinations thereof.

In this specification, each of the phrases “A or B,” “at least one of A and B,” “at least one of A or B,” “A, B, or C,” “at least one of A, B, and C,” and “at least one of A, B, or C” may include any one of the items listed in the phrase or all possible combinations thereof.

Unless otherwise defined, all terms including technical or scientific terms used herein have the same meanings as generally understood by those of ordinary skill in the art. Terms defined in commonly used dictionaries should be construed as having meanings consistent with their meanings in the context of the related art and should not be construed as having an idealized or overly formal sense unless expressly defined in this specification.

Exemplary embodiments may be implemented as various products such as a personal computer (PC), a laptop computer, a tablet computer, a smartphone, a television, a smart appliance, an intelligent vehicle, a kiosk, a wearable device, and the like. Hereinafter, exemplary embodiments will be described in detail with reference to the accompanying drawings. In describing the exemplary embodiments with reference to the accompanying drawings, like reference numerals refer to like components, and repetitive description thereof will be omitted.

Measuring the attribution of input features to the output of an artificial neural network model may be an important issue for finding the basis for the outputs of deep neural networks (DNNs). Among various approaches for calculating an attribution, a gradient-based method may be mainly used because of its ease of implementation and the model-agnostic characteristic. However, with existing methods, such as integrated gradients (IG), it suffer from noise which degrades reliability and a selection for a path of determining quality. FullGrad (FG) may be another approach for constructing reliable attributions centering on the locality of a piece-wise linear network with the bias gradient. FG shows reasonable performance for given inputs, while IG which includes the exploration over the input space, but FG may be vulnerable to small perturbations due to the shortage of global properties. In the following description, it is possible to design a new input feature attribution method that adopts the strengths of both local and global attributions. In particular, a method of distilling input features using a mask extractor is proposed. The present disclosure provides reliable attribution by aggregating intermediate local attributions obtained in a distillation process.

Gradient-based input attribution is one of the main techniques to derive the relationship between a model decision and input features. The partial derivative of an output with respect to an input provides the measure of sensitivity, which is calculated in DNNs. IG is a commonly used gradient-based method and provides axiomatic properties that support the reliability of attributions. However, IG is a commonly used gradient method that provides axiomatic properties that support the trustworthiness of attributions. However, IG has inherent noisy attribution, which originates from a gradient integrating path and several variants of IG, and several variants of IG have been proposed to alleviate this issue. FG also raises the counter-intuitive behaviors of IG. FG avoids this problem by considering only local gradients instead of path integration and proposes to use the bias gradient. Due to its locality, FG is vulnerable to small perturbations in the inputs due to its locality.

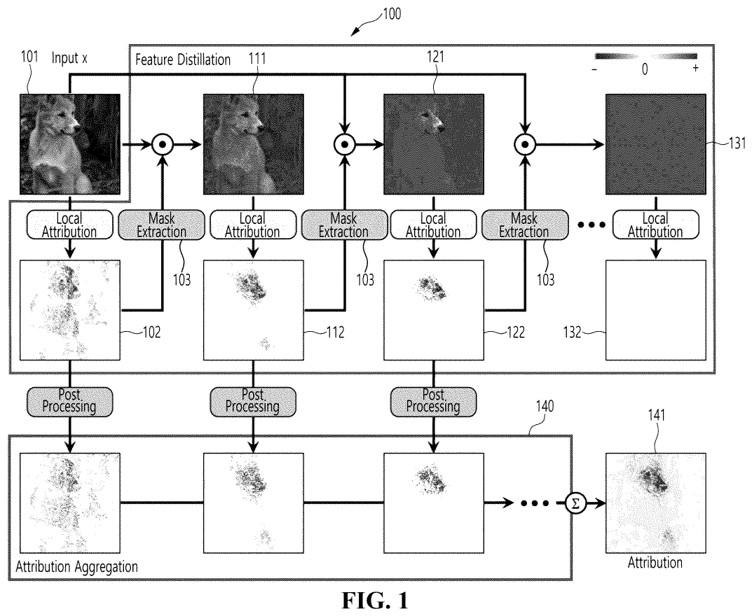

A device and method for compensating for (1) an inevitable weakness of FG method when only a single anchor point is taken into consideration, and (2) the weakness that IG method, a continuous path-based gradient integral, may fail to quantify intuitive attribution will be described with reference to FIGS. 1 to 11 below. Specifically, a device and method for aggregating attribution from a plurality of anchors to compensate for the weaknesses of the two methods will be described. Also, for the selection of anchor points, an algorithm for sequentially distilling irrelevant features to produce reliable attribution will be described.

FIG. 1 is a block diagram illustrating a method of distilling input features through an artificial neural network model according to an exemplary embodiment.

One or more blocks of FIG. 1 and a combination of the blocks may be implemented by a special-purpose hardware-based computer that performs a specific function or a combination of special-purpose hardware and computer instructions.

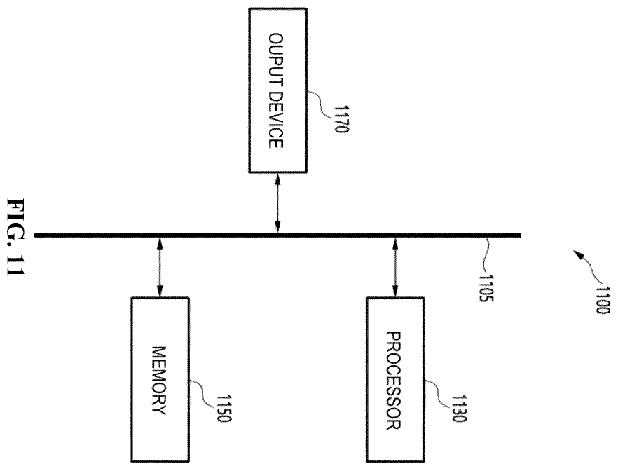

A processor may control overall operations of an electronic device. The processor may be a processor 1130 of FIG. 11, and the electronic device may be an electronic device 1100 of FIG. 11. The following description of a device and method for distilling input features illustrated in FIGS. 1 to 10 may be implemented by the electronic device 1100. In an exemplary embodiment, the processor 1130 may be implemented as the array of a plurality of logic gates or a combination of a general-use microprocessor and a memory in which a program executable by the microprocessor is stored. In addition, those of ordinary skill in the art will understand that the processor 1130 may be implemented in another form of hardware.

The processor 1130 according to the exemplary embodiment may distill input features (100). In other words, the processor 1130 may generate a discrete sequence of anchor points by extracting input features. The processor 1130 may compare an output of an artificial neural network model with an initial input (e.g., a first input 101) to extract a first local attribution 102. The processor 1130 may extract a portion of the first local attribution 102 which is a threshold or more through a mask extractor 103. The extraction result may be a first attribution heatmap. The processor 1130 may update the first input 101 with a second input 111 by applying the extraction result to the first input 101.

The processor 1130 may extract a second local attribution 112 for a feature of a second input 111 by comparing an output of the artificial neural network model with the second input 111. The processor 1130 may extract a portion of the second local attribution 112 which is a threshold or more using the mask extractor 103. The threshold of the second local attribution 112 may differ from the threshold of the first local attribution 102. The processor 1130 may update the second input 111 with a third input 121 by applying the extraction result to the second input 111. The processor 1130 may extract a third local attribution 122 from the third input 121. The processor 1130 may generate N local attributions and N input features by repeating the foregoing steps N times. The processor 1130 may generate an N^{th} input 131 for which no feature exists and an N^{th} local attribution 132 of which no attribution exists.

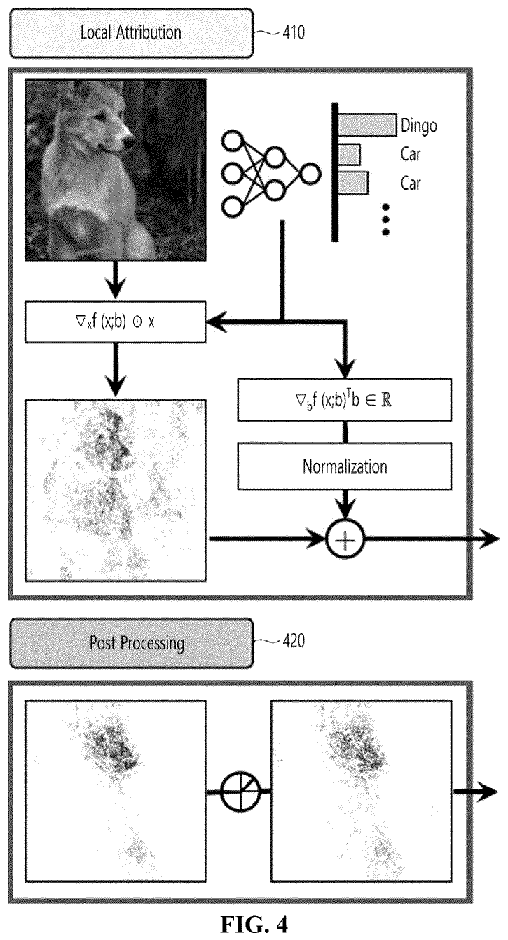

The processor 1130 may acquire a final attribution 141 by aggregating local attributions. The processor 1130 may perform postprocessing on each local attribution (e.g., 102, 112, 122, . . . , and 132) and add the local attributions subjected to postprocessing in a distillation sequence, generating the final attribution 141. Local attributions and postprocessing will be described in detail below with reference to FIG. 4.

As shown in FIG. 1, the processor 1130 may generate local attributions and attribution heatmaps.

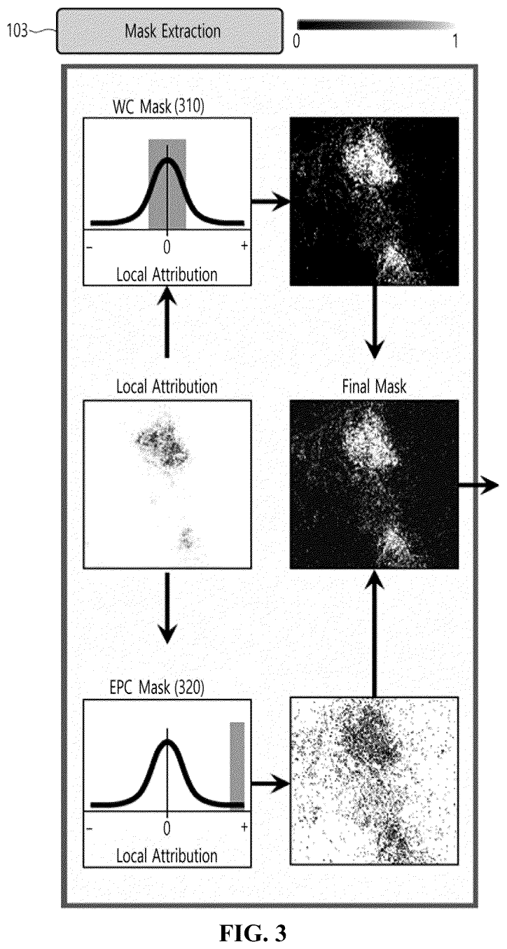

The processor 1130 according to the exemplary embodiment may include the mask extractor 103. The mask extractor 103 may include at least one of a first mask and a second mask. FIG. 3 schematically shows a configuration and operations of the mask extractor 103. In FIG. 3, a Weak Contributor (WC) mask 310 is a first mask, and an Extreme Positive Contributor (EPC) mask 320 is a second mask.

To remove features with low attribution, the mask extractor 103 may be defined by a relationship shown in Equation 1 below.

$$\tilde{x} ( n + 1 ) = M ( \tilde{x} ( n ) ) ⊙ \tilde{x} ( 0 ) \qquad [ Equation 1 ]$$

In Equation 1, \tilde{x}(0)=x, and M(·) is a mask extractor.

According to an exemplary embodiment, the mask extractor may be defined as the WC mask 310 (M^{WC}). A level of the WC mask 310 may increase according to a predefined number of steps N, and pixels of an N^{th} input 131 which is the last input may become zero (i.e., \tilde{x}(N)=0). The WC mask 310 (M^{WC}(·)) for each feature j may be defined as shown in Equation 2 below.

$${S}_{j}^{WC} ( x ) = \{ k \vert \vert {ϕ}_{k}^{UFG} ( x ) \vert \leq \vert {ϕ}_{j}^{UFG} ( x ) \vert \} \qquad [ Equation 2 ]$$

$${M}_{j}^{WC} ( x , n ; N ) = \{ \begin{matrix}0 & if \frac{{S}_{j}^{WC} ( x )}{dim ( x )} \leq \frac{n}{N} \\ 1 & otherwise\end{matrix}$$

In Equation 2, Sⱼ^{WC}(x) may be a set of feature indices of which corresponding local attributions have a magnitude smaller than |ϕⱼ^{UFG}(x)|. Mⱼ^{WC}(x, n; N) may be equivalently derived by thresholding with n/N quantile of absolute local attributions. To implement the smooth change of features, the WC mask 310 may be gradually applied along with a scale factor which is in proportion to a current step n. A sequential relationship with the WC mask 310 may be defined as shown in Equation 3 below.

$$\tilde{x} ( n + 1 ) = \frac{n}{N} {M}^{WC} ( \tilde{x} ( n ) , n ; N ) ⊙ \tilde{x} ( 0 ) \qquad [ Equation 3 ]$$

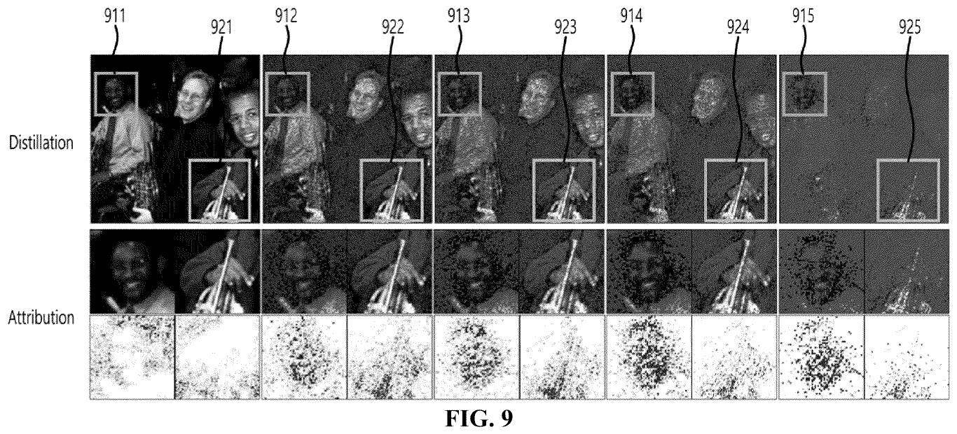

FIG. 9 shows a sequence of an input \tilde{x} distilled with the WC mask 310 and a sequence of local attributions. The bottom row of FIG. 9 shows local attributions ϕ^{UFG}(\tilde{x}(n)) for boxes shown in the first row. Referring to FIG. 9, uninformative features (e.g., human bodies and portions with local attributions of a threshold or less) are removed through distillation with the WC mask 310 to predict a French horn 921 to 925 which is an object class.

However, when the processor 1130 only uses the WC mask 310, strong local attributions may be temporarily assigned to corresponding features, and irrelevant features may not be distilled. For example, in FIG. 9, a face 911 to 915 may be left with a strong attribution until distillation is finished. This may happen when there is noise in the gradient of an input feature or a feature value is too large, and may cause an extremely high attribution for pixels that do not have information related to prediction of a target class. When high attribution values are assigned to such pixels, the WC mask 310 repeatedly reassigns the masks to the same pixels and makes the overall distillation sequence be saturated. A saturated distillation sequence \tilde{x} disturbs the strength of multiple ablated inputs to build reliable attribution.

Therefore, an additional mask may be defined to reduce saturation by filtering features with an extremely strong attribution.

According to the exemplary embodiment, an additional mask may be defined as the EPC mask 320 (M^{EPC}(·)). The EPC mask 320 (M^{EPC}(·)) may be defined by Equation 4 below.

$${S}_{j}^{EPC} ( x ) = \{ k \vert {ϕ}_{k}^{UFG} \leq {ϕ}_{j}^{UFG} ( x ) \} \qquad [ Equation 4 ]$$

$${M}_{j}^{EPC} ( x ; q ) = \{ \begin{matrix}1 & if \frac{\vert {S}_{j}^{EPC} ( x ) \vert}{dim ( x )} \leq q \\ 0 & otherwise\end{matrix}$$

In Equation 4, q is an EPC threshold for adjusting a ratio of ablation. As a result, combining two masks using a relative weight for the current step n may be expressed by Equation 5 below.

$$\tilde{x} ( n + 1 ) = ( \frac{n}{N} {M}^{WC} ( \tilde{x} ( n ) , n ; N ) + ( 1 - \frac{n}{N} ) {M}^{EPC} ( \tilde{x} ( n ) ; q ) ) ⊙ \tilde{x} ( 0 ) \qquad [ Equation 5 ]$$

In early distillation step, the processor 1130 may give a high weight to the EPC mask 320 to reduce saturation in features with extremely strong attribution. In a subsequent step, the processor 1130 may give a high weight to the WC mask 310 to leave relevant features.

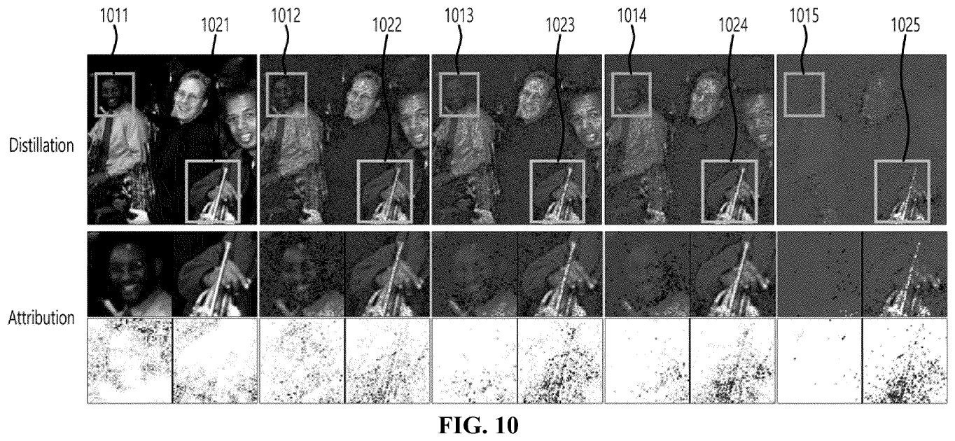

FIG. 10 shows a distillation sequence \tilde{x} distilled with the WC mask 310 and the EPC mask 320. The bottom row of FIG. 10 shows local attributions ϕ^{UFG}(\tilde{x}(n)) for boxes shown in the first row. When the WC mask 310 and the EPC mask 320 are used, a face 1011 to 1015 which is irrelevant feature to outputs is removed, and an attribution is repeatedly assigned to a French horn 1021 to 1025 which is relevant feature to outputs.

The processor 1130 may acquire N local attributions through N distillation steps. Before aggregating local attributions to acquire the final attribution 141, the processor 1130 may acquire a positive contribution from each local attribution by executing a rectified linear unit (ReLU). A method in which the processor 1130 acquires the final attribution 141 may be expressed by Equation 6 below.

$${ϕ}^{DGA} ( x ) = \frac{1}{N} {\sum }_{n = 1}^{N} ReLU ( {ϕ}^{UFG} ( \tilde{x} ( n ) ) ) \qquad [ Equation 6 ]$$

The foregoing method may be defined as an algorithm which is expressed by Equation 7 below.

[Equation 7]
Algorithm 1 Distilled Gradient Aggregation

| Input: Model f, Input x | | |
|---|---|---|
| Parameter: # of steps N, EPC threshold q, Negative scale β | | |
| Output: Attribution ϕ^{DGA}(x) | | |
| | 1: | Let \tilde{x}(0) = x, Φ = Ø |
| | 2: | for n in {0 . . . N} do |
| | 3: | Φ = Φ ∪ {ϕ^{UFG} (\tilde{x}(n))} |
| | 4: | $M = \frac{n}{N} {M}^{W C} ( \tilde{x} ( n ) , n ; m ) + ( 1 - \frac{n}{N} ) {M}^{E P C} ( \tilde{x} ( n ) ; q )$ |
| | 5: | \tilde{x}(n + 1) = \tilde{x}(0) ⊙ M |
| | 6: | end for |
| | 7: | ϕ^{DGA}(x) = Σ_{ϕ∈Φ} ReLU(ϕ) |
| | 8: | return ϕ^{DGA}(x) |

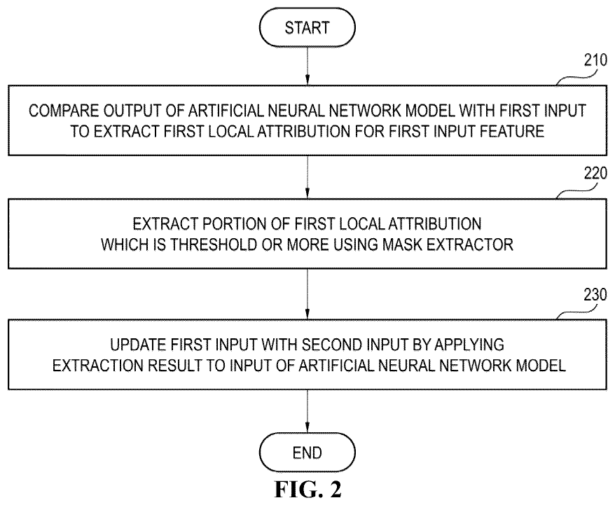

FIG. 2 is a flowchart illustrating operations of a processor according to an exemplary embodiment.

The description of FIG. 1 may also apply to FIG. 2, and repetitive description may be omitted.

Operations of FIG. 2 may be performed in the illustrated order and manner, but without departing from the spirit and scope of the illustrated embodiment, the order of some operations may be changed or some operations may be omitted. The plurality of operations illustrated in FIG. 2 may be performed in parallel or simultaneously.

In operation 210, the processor 1130 according to the exemplary embodiment may compare an output of the artificial neural network model with the first input 101 and extract the first local attribution 102 for the first input feature. The processor 1130 may generate an attribution heatmap of the first local attribution 102.

In operation 220, the processor 1130 according to the exemplary embodiment may extract a portion of the first local attribution 102 which is a threshold or more using a mask extractor.

The mask extractor according to an exemplary embodiment may include a first mask that sets the threshold on the basis of the distribution of the first local attribution 102 and determines an attribution of a portion of the first local attribution 102 which is the threshold or less to be 0. For example, referring to FIG. 1, the threshold of the first mask is assumed to be 0.2. When attributions of the outside of the background are 0.1 in an attribution heatmap of the first local attribution 102, the first mask may determine the attributions of the outside of the background to be 0. Subsequently, the first mask may extract the attribution heatmap other than a portion of which an attribution is 0. As described above in FIG. 1, the threshold of the first mask may vary depending on the distribution of local attributions according to the operating sequence of the processor 1130. Also, the processor 1130 may include a second mask for removing noise and outliers of the first local attribution 102.

The mask extractor according to the exemplary embodiment may remove a portion of the first local attribution 102 where the attribution is determined to be 0.

In operation 230, the processor 1130 according to the exemplary embodiment may update the first input 101 with the second input 111 by applying the extraction result to an input of the artificial neural network model. For example, the processor 1130 may update the first input 101 with the second input 111 by applying results extracted through the first mask and the second mask to the first input 101.

As an example, the background of the second input 111 is determined by the first mask to have an attribution of 0 and thus may be expressed as the weakened background of the first input 101. The processor 1130 may repeatedly perform the foregoing process to continuously weaken the background of the first input 101 and the puppy's body part of the first input 101. When the processor 1130 repeats the foregoing process N times and finally all attributions of local attribution are determined to be 0, the processor 1130 may finish the input feature distillation step.

The processor 1130 may store local attributions extracted from distilled input features in a memory.

The processor 1130 may compare the output of the artificial neural network model with the second input 111 and extract the second local attribution 112 for the second input feature. The processor 1130 may aggregate the first local attribution 102 and the second local attribution 112 to acquire an aggregated attribution. The processor 1130 may perform postprocessing (including normalization and upsampling) on the first local attribution 102 and the second local attribution 112. Although only the first local attribution 102 and the second local attribution 112 are described in the disclosed embodiment, the processor 1130 may generate N local attributions by performing the input feature distillation step N times. In other words, the processor 1130 may generate the discrete sequence of anchor points. Also, the processor 1130 may perform postprocessing on each of the N local attributions and then acquire an aggregated attribution.

For example, the processor 1130 may perform postprocessing on each of the N local attributions and then add the N local attributions (140) to acquire the final attribution 141.

FIG. 3 is a schematic diagram illustrating a mask extractor according to an exemplary embodiment.

The descriptions of FIGS. 1 and 2 may also apply to FIG. 3, and repetitive description may be omitted.

The mask extractor 103 according to the exemplary embodiment may include the WC mask 310 which is a first mask and the EPC mask 320 which is a second mask. The WC mask 310 is a mask for extracting a portion of normalized local attributions 330 whose attributions are greater than a threshold or more. The EPC mask 320 which is the second mask may be a mask for filtering out features having extremely strong attributions. Since a mask extractor has been described in detail in FIGS. 1 and 2, repetitive description thereof will be omitted.

FIG. 4 is a schematic diagram illustrating local attributions and postprocessing according to an exemplary embodiment.

The processor 1130 according to the exemplary embodiment may calculate local attributions 410 (e.g., the local attributions of FIG. 1) and perform postprocessing 420 on the local attributions 410.

Methods for the processor 1130 to derive attributions (e.g., local attributions) of input features may include various methods that may be performed by those of ordinary skill in the art. For example, according to a Class Activation Mapping (CAM) method, an attribution is obtained by calculating a weighted sum of feature maps. According to a Layer-wise Relevance Propagation (LRP) method, a model output is propagated backward to the input. The LRP extends Taylor decomposition to DNNs and distributes the relevance in a layer-wise sense.

As another example, there is an approach for measuring a model's behavior by perturbing input features. Gradient-ascent input optimization provides an example of maximally activating a target neuron. Instead of maximizing target neuron activation, Extremal Perturbation may optimize a mask that removes or reveals a portion of an input to localize an attributed portion of the input. This method is extended using IG for optimization and makes optimization more stable. Pairs of a partially removed input and an output of a corresponding model may be collected, and a linear model may be trained to resemble this mapping so that feature importance may be acquired in terms of linear weights. Instead of training a new model, a Randomized Input Sampling for Explanation (RISE) method may include aggregating a variety of randomly masked inputs which are weighted by model outputs, and calculating the attribution. A method of calculating the attributions of input features is not limited to the foregoing embodiments.

To calculate reliable local attributions, the processor 1130 may perform FG. FG limits bias gradients through postprocessing Ψ(·) including normalization and upsampling. Ψ(·) proposed in FG is usually over-estimated by the bias gradient in deeper layers. Accordingly, to alleviate the over-estimation problem, the postprocessing Ψ(·) may be redefined as a uniformly distributing function for the bias gradient, as shown in Equation 8 below.

$${Ψ}_{u} ( v ) = \frac{{v}^{T} {1}^{dim ( v )}}{dim ( x )} {1}^{dim ( x )} \qquad [ Equation 8 ]$$

In Equation 8, 1^{d} represents a d-dimensional all-ones vector. FG with the redefined postprocessing Ψ(·) may be referred to as “Uniform FullGrad (UFG)” ℠^{UFG}(·). UFG may be used as an intermediate local attribution calculation method throughout the rest of the specification. A method of calculating the local attributions 410 and the postprocessing 420 are not limited to the disclosed embodiment, and another local attribution calculation method and postprocessing 420 known to those of ordinary skill in the art may be used.

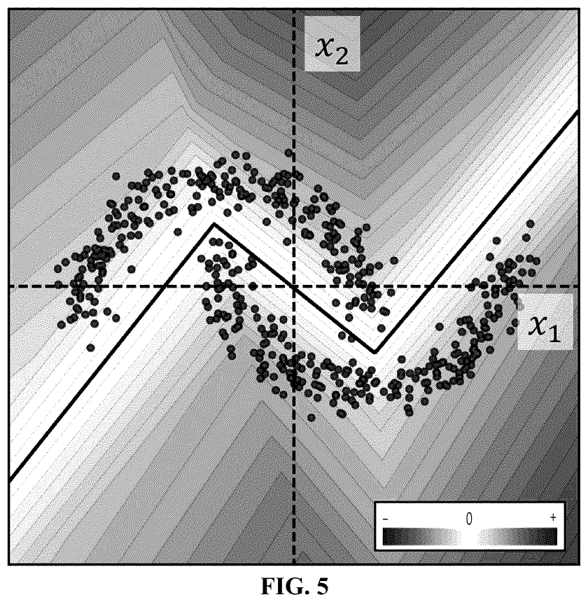

FIGS. 5 to 8 are diagrams illustrating IG and FG according to an exemplary embodiment.

IG may be proposed on the basis of an Aumann-Shapley value which is one solution of a fair distribution solution in cooperative game theory. IG is equipped with axiomatic properties which are desirable for attribution methods. IG is calculated by integrating gradients over a straight path from a predefined baseline to an input. Since attributions are damaged by noisy information generated along the path, alternatives of other paths are proposed. FG utilizing bias gradients is proposed to suppress the counter-intuitive behavior of IG which is caused by weak dependency between local linear regions. IG and FG will be described in detail below with reference to FIGS. 5 to 8.

It is assumed that there is an input vector x∈R² and a simple neural network f is equipped with partial linear activation (e.g., ReLU). The network f may be regarded as the combination of piece-wise linear functions. Each piece-wise linear function is only defined and feasible in a corresponding linear region R^{(k)}, where UₖR^{(k)}=R² and R^{(k1)}∩R^{(k2)}=∅ for any k₁ and k₂. Such piece-wise linear function may be defined by Equation 9 below.

$$f ( x ) = \{ \begin{matrix}{w}^{( 1 ) T} x + {b}^{( 1 )} & x ∈ {R}^{( 1 )} \\ … & \\ {w}^{( K ) T} x + {b}^{( K )} & x ∈ {R}^{( K )}\end{matrix} \qquad [ Equation 9 ]$$

In Equation 9, w(k)∈R² and b(k)∈R denote weight and bias of a k^{th} linear region, respectively.

FIGS. 5 to 8 depict an illustrative example of the function f². For the network f, FG and IG are given by Equation 10 below.

$$F G ( x ) = Ψ ( {∇}_{x} f ( x ) ⊙ x ) + {\sum }_{l ∈ L} {\sum }_{c ∈ {c}_{l}} Ψ ( {∇}_{{b}_{c}} f ( x ) {b}_{c} ) \qquad [ Equation 10 ]$$

$$IG ( x ) = {\int }_{α = 0}^{1} {∇}_{γ ( α )} f ( γ ( α ) ) ⊙ {∇}_{α} γ ( α ) d α$$

FG suggests that the attribution should be same inside the same linear region R^{(k)}, and this reduces the dependency between the attribution and the input x. This property is introduced as weak dependency. However, such weak dependency derives the attribution to be vulnerable to model perturbation. For example, there are two inputs x and x′=x+ϵ, where ϵ is any small enough random perturbation. When any x and x′ are found, such that the model output is same, that is, f(x)=f(x′) but, the region is different, then the attribution on each input should be different. This may be visualized by the simple experiment by generating a noise-perturbed image x+ϵ and measuring the attribution, where ϵ˜N(0, σI). Although not shown in the drawings, FG may generate inconsistent attributions along with the simple Gaussian noise is added.

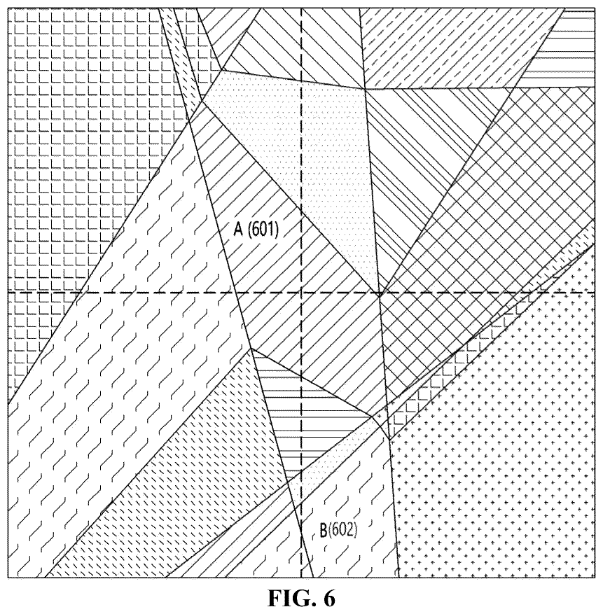

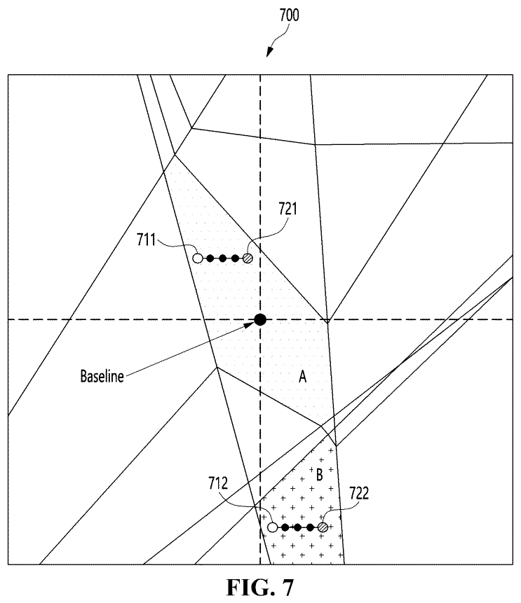

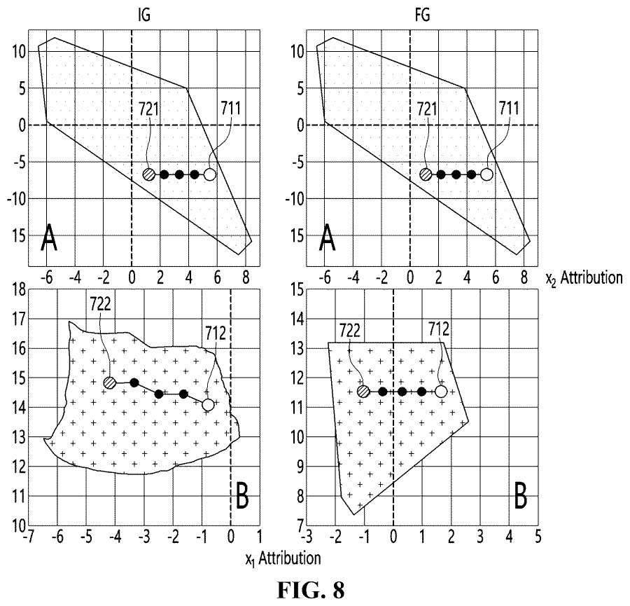

FIG. 5 shows a contour of logit values for trained f. FIG. 6 shows linear regions constituting a trained network. Each linear region corresponds to each piece-wise linear function. FIG. 7 shows two selected linear regions A and B and the zero baseline. The dotted lines indicate perturbations for x₁ axes in the same linear region. FIG. 8 shows attribution of IG and FG for each linear region. In the case of a linear region A (including the baseline), global attributions (IG) are the same as local attributions (FG). However, in a linear region B, the global attribution and local attribution have different attributions for input samples.

To visualize the counter-intuitive behavior of IG, two linear regions A (601) and B (602) may be selected in FIG. 7, and an attribution may be calculated in each region. For example, data sequences from white dots 711 and 712 to green dots 721 and 722 are selected, which are only shifted in an x₁ dimension.

FIG. 8 shows IG attribution and FG attribution for two selected linear regions. It is observed that only x₁ attribution changes for the sequence of the region A (601) in both IG and FG methods. However, for the sequence of the region B, IG attribution of both x₁ and x₂ changes at the same time, while FG attribution shows attribution change only in x₁. This counter-intuitive behavior of IG may be conjectured to be caused by the baseline selection. For example, with the zero-baseline (\tilde{x}=0), the integration paths of samples in the region A traverse only a single region to calculate an IG. On the other hand, the paths of samples in the region B traverse through multiple regions. In the case of traversing multiple regions, the counter-intuitive behavior may be induced by passing undesirable linear regions. From this observation, it is identified that the selection of a baseline determines (1) which linear regions are traversed by the path, and (2) how many portions of the path are included in each selected linear region. Although the proper selection of a baseline may be one option for adjusting (1) and (2) for reliable attributions, it is still not easy to control the sequence of meaningful linear regions and each weight by only changing the baseline.

An attribution method of combining the strengths of types of attribution methods to alleviate the shortcomings of local and global attribution methods, such as vulnerabilities and counter-intuitive behavior has been described in detail with reference to FIGS. 1 to 4.

As a strategy for selecting linear regions, RISE suggests a random perturbation-based approach. RISE explores multiple linear regions with randomly ablated masks to measure the importance of each ablated feature. However, the randomized ablation includes a stochastic process which requires a high computational cost to achieve reliable attributions. Also, adaptive selection for perturbed inputs in guided IG (GIG) may improve the final attribution. Accordingly, given this, adaptive exploration of linear regions based on intermediate local attribution can reduce the cost of randomized exploration. FIGS. 1 to 4 described above illustrate a sequential feature distillation algorithm for obtaining a sequence of ablated inputs.

FIGS. 9 and 10 are diagrams illustrating results of a mask extractor according to an exemplary embodiment.

The descriptions of FIGS. 1 to 8 may also apply to FIGS. 9 and 10, and repetitive description may be omitted.

FIG. 9 shows a sequence of distilled inputs and a sequence of local attributions when only the WC mask 310 is used. The face 911 to 915 may work as noise for the WC 310 and thus may not be distilled out from the inputs. Accordingly, in comparison with the French horn 921 to 925 which is the output of the artificial neural network model of the processor, attributions still exist in the face 911 to 915.

FIG. 10 shows a sequence of distilled inputs and a sequence of local attributions when the processor uses the WC mask 310 and the EPC mask 320. The face 1011 to 1015 is determined as noise by the EPC mask 320 and gradually weakened. Accordingly, in comparison with the French horn 1021 to 1025 which is the output of the artificial neural network model of the processor, attributions do not exist in the face 1011 to 1015.

FIG. 11 is a block diagram of an electronic device according to an exemplary embodiment.

Referring to FIG. 11, the electronic device 1100 according to an exemplary embodiment may include the processor 1130, a memory 1150, and an output device 1170. The processor 1130, the memory 1150, and the output device 1170 may be connected to each other through a communication bus 1105.

The output device 1170 may display a state related to input feature distillation provided by the processor 1130 along with a user interface for receiving a user input for manipulation. An example of the output device 1170 may be a display.

The memory 1150 may store data (e.g., local attributions) related to input feature distillation performed by the processor 1130. Further, the memory 1150 may store various information generated in the foregoing process of the processor 1130. In addition, the memory 1150 may store various data, programs, and the like. The memory 1150 may include a volatile memory or non-volatile memory. The memory 1150 may have a large-capacity storage medium, such as a hard disk, to store various data.

The processor 1130 may perform the at least one method described above with reference to FIGS. 1 to 10 or an algorithm corresponding to the at least one method. In the foregoing process, the processor 1130 may be a data processing device implemented as hardware including a circuit having a physical structure for executing desired operations. For example, the desired operations may involve code and instructions included in a program. The processor 1130 may be configured as, for example, a central processing unit (CPU), a graphics processing unit (GPU), or a neural network processing unit (NPU). For example, the electronic device 1100 implemented as hardware may include a microprocessor, a CPU, a processor core, a multicore processor, a multiprocessor, an application-specific integrated circuit (ASIC), and a field programmable gate array (FPGA).

The processor 1130 may execute a program and control the electronic device 1100. Program code executed by the processor 1130 may be stored in the memory 1150.

The foregoing embodiments may be implemented as hardware components, software components, and/or a combination of hardware components and software components. For example, the devices, methods, and components described in the embodiments may be implemented using a general-use computer or special-purpose computer such as a processor, a controller, an arithmetic logic unit (ALU), a digital signal processor, a microcomputer, a field programmable gate array (FPGA), a programmable logic unit (PLU), a microprocessor, or any device which may execute instructions and respond. A processing device may execute an operating system (OS) and software applications running on the OS. Further, the processing device may access, store, manipulate, process, and generate data in response to execution of software. Although it is described that one processing device is used to facilitate understanding in some cases, it will be understood by those skilled in the art that the processing device may include a plurality of processing elements and/or a plurality of types of processing elements. For example, the processing device may include a plurality of processors or one processor and one controller. Also, the processing device may be a different processing configuration such as a parallel processor.

Software may include computer programs, code, instructions, or a combination thereof and configure a processing device to operate in a desired manner or control the processing device independently or collectively. Software and/or data may be permanently or temporarily embodied in any type of machine, component, physical device, virtual equipment, computer storage medium or device, or transmitted signal waves to be interpreted by the processing device or to provide instructions or data to the processing device. Software may be distributed throughout computer systems connected to a network and may be stored or executed in a distributed manner. Software and data may be stored in a computer-readable recording medium.

The method according to an embodiment may be implemented in the form of a program instruction and may be recorded on a computer-readable recording medium. The computer-readable recording medium may also include program instructions, data files, data structures, and the like solely or in combination. The program instructions recorded on the medium may be designed and configured specially for the embodiment or may be known and available to those skilled in the field of computer software. Examples of the computer-readable recording medium include magnetic media, such as a hard disk, a floppy disk, and magnetic tape, optical media, such as a compact disc read-only memory (CD-ROM) and a digital versatile disc (DVD), and hardware devices specially configured to store and execute program instructions such as a ROM, a random access memory (RAM), a flash memory, and the like. Examples of program instructions include not only machine code created by a compiler but also high-level language code that is executable by a computer using an interpreter or the like.

With a device and method for distilling input features through an artificial neural network model according to exemplary embodiments of the present disclosure, it is possible to provide a new input feature attribution method that adopts the strengths of local attribution and global attribution.

With a device and method for distilling input features through an artificial neural network model according to exemplary embodiments of the present disclosure, it is possible to provide reliable attribution by aggregating intermediate local attributions obtained from a distillation sequence.

Effects of the present disclosure are not limited to those described above, and other effects which have not been mentioned above will be clearly understood by those skilled in the technical field to which the present disclosure pertains from the present specification and the accompanying drawings.

Although embodiments have been described above with reference to limited drawings, it will be apparent to those skilled in the art that various modifications and variations can be made from the descriptions. For example, adequate effects may be achieved even when the above descriptions are carried out in a different order than described above, and/or described components, such as systems, structures, devices, circuits, and the like are coupled or combined in different forms than those described above or substituted or switched with other components or equivalents.

Therefore, other implementations, other embodiments, and equivalents of the claims fall within the scope of the claims.

What is claimed is:

1. A method of distilling input features through an artificial neural network model, the method comprising:
comparing an output of an artificial neural network model with a first input to extract a first local attribution for a feature of the first input;
extracting a portion of the first local attribution of which an absolute value is a threshold or more using a mask extractor; and
updating the first input with a second input by applying an extraction result to the first input.

2. The method of claim 1, further comprising:
comparing the output of the artificial neural network model with the second input to extract a second local attribution for the second input; and
acquiring an aggregated attribution by aggregating the first local attribution and the second local attribution.

3. The method of claim 2, wherein the acquiring of the aggregated attribution comprises performing postprocessing on the first local attribution and the second local attribution,
wherein the postprocessing includes normalization and upsampling.

4. The method of claim 1, wherein the mask extractor comprises a first mask configured to set the threshold on the basis of a distribution of the first local attribution and determine an attribution of a portion of the first local attribution which is the threshold or less to be 0.

5. The method of claim 4, wherein the updating of the first input with the second input comprises removing the portion of the first local attribution of which the attribution is determined to be 0.

6. The method of claim 1, wherein the mask extractor comprises a second mask configured to remove noise and outliers of the first local attribution.

7. The method of claim 1, wherein the first local attribution is a discrete sequence of anchor points.

8. The method of claim 1, wherein the extracting of the first local attribution comprises generating an attribution heatmap of the first local attribution.

9. A non-transitory computer-readable recording medium storing instructions that are executed by a processor to perform the operations of:
comparing an output of an artificial neural network model with a first input to extract a first local attribution for a feature of the first input;
extracting a portion of the first local attribution of which an absolute value is a threshold or more using a mask extractor; and
updating the first input with a second input by applying an extraction result to the first input.

10. An electronic device for distilling input features, comprising:
a memory configured to store instructions; and
a processor configured to execute the instructions,
wherein the processor is configured to:
compare an output of an artificial neural network model with a first input to extract a first local attribution for a feature of the first input,
extract a portion of the first local attribution of which an absolute value is a threshold or more using a mask extractor, and
update the first input with a second input by applying an extraction result to the first input.

11. The electronic device of claim 10, wherein the processor is further configured to:
compare the output of the artificial neural network model with the second input to extract a second local attribution for the second input, and
acquire an aggregated attribution by aggregating the first local attribution and the second local attribution.

12. The electronic device of claim 11, wherein the processor is configured to perform postprocessing on the first local attribution and the second local attribution,
wherein the postprocessing includes normalization and upsampling.

13. The electronic device of claim 10, wherein the mask extractor comprises a first mask configured to set the threshold on the basis of a distribution of the first local attribution and determine an attribution of a portion of the first local attribution which is the threshold or less to be 0.

14. The electronic device of claim 13, wherein the processor is configured to update the first input with the second input and remove the portion of the first local attribution of which the attribution is determined to be 0.

15. The electronic device of claim 10, wherein the mask extractor comprises a second mask configured to remove noise and outliers of the first local attribution.

16. The electronic device of claim 10, wherein the first local attribution is a discrete sequence of anchor points.

17. The electronic device of claim 10, wherein the processor is configured to generate an attribution heatmap of the first local attribution.
